(19) United States
(12) Patent Application Publication
(10) Pub. No.: US 2025/0319864 A1
(43) Pub. Date: Oct. 16, 2025

(54) Method and Apparatus for Controlling Vehicle

(71) Applicants: Hyundai Motor Company, Seoul (KR); Kia Corporation, Seoul (KR)

(72) Inventors: Won Sik Jung, Suwon-Si (KR); Hyoung Jong Wi, Seoul (KR)

(21) Appl. No.: 18/967,831

(22) Filed: Dec. 4, 2024

(30) Foreign Application Priority Data
Apr. 12, 2024 (KR) 10-2024-0049186

(51) Int. Cl. B60W 30/09; B60W 40/04

(52) U.S. Cl. CPC B60W 30/09; B60W 40/04; B60W 2552/10; B60W 2554/4041; B60W 2554/4045; B60W 2554/4046

(57) ABSTRACT

A method and apparatus for controlling vehicle. A vehicle control method performed by an apparatus of a host vehicle may include: comparing a behavior of a target vehicle with a behavior of a trailer that is connected to the target vehicle; determining, based on the behavior of the target vehicle being different from the behavior of the trailer, that the target vehicle and the trailer are linked targets that affect each other, determining, based on the linked targets, a possibility of a collision between the host vehicle and the target vehicle to which the trailer is connected; and controlling, based on the possibility of the collision, an operation of the host vehicle.

### CROSS-REFERENCE TO RELATED APPLICATION

This application claims priority to Korean Patent Application No. 10-2024-0049186, filed on Apr. 12, 2024 in the Korea Intellectual Property Office, the entire contents of which are incorporated herein by reference.

### TECHNICAL FIELD

The present disclosure relates to a method and apparatus for controlling vehicle, and more particularly, to a method and apparatus for collision prevention.

### BACKGROUND

The statements in this section merely provide background information related to the present disclosure and do not constitute prior art.

In order to reduce the burden on drivers and increase convenience, research has been actively conducted on an advanced driver-assistance system (ADAS) that actively provides information on the drivers' conditions and surrounding environments.

An example of the ADAS is a collision avoidance system (also referred to as a collision prevention system). The collision avoidance system may monitor an absolute speed of a vehicle, a distance between vehicles, etc., analyze a possibility of a collision, send a warning signal to the driver, perform emergency braking, or steer the vehicle based on the analysis results to prevent or alleviate collision. The collision avoidance system may include a forward collision-avoidance assist (FCA) system, a lane following assist (LFA) system, a lane keeping assist (LKA) system, a blind-spot collision warning (BCW) system, etc.

### SUMMARY

The present disclosure is to prevent a collision between a target vehicle to which a trailer is connected and a subject vehicle. More specifically, the present disclosure provides a method and apparatus for controlling vehicle capable of effectively performing collision avoidance by considering a target vehicle and a trailer as two entities dependent on each other when behaviors of the target vehicle and the trailer are different and predicting a future location of the trailer based on the behavior of the target vehicle.

The problems to be solved by the present disclosure are not limited to the problems mentioned above, and other problems not mentioned will be clearly understood by those skilled in the art from the description below.

According to one or more example embodiments of the present disclosure, a method performed by an apparatus of a host vehicle may include: comparing a behavior of a target vehicle with a behavior of a trailer that is connected to the target vehicle; determining, based on the behavior of the target vehicle being different from the behavior of the trailer, that the target vehicle and the trailer are linked targets that affect each other; determining, based on the linked targets, a possibility of a collision between the host vehicle and the target vehicle to which the trailer is connected; and controlling, based on the possibility of the collision, an operation of the host vehicle.

Determining the possibility of the collision may include: determining, based on the behavior of the target vehicle, an estimated future location of the trailer; and determining whether at least one of a current location of the target vehicle, a current location of the trailer, or the estimated future location of the trailer is in an interference zone located in front of the host vehicle within a threshold distance.

Determining the possibility of the collision may include: determining, based on at least one of the current location of the target vehicle, the current location of the trailer, or the estimated future location of the trailer being in the interference zone, that the possibility of the collision is above a threshold value.

Controlling the operation of the host vehicle may include: determining, based on the possibility of the collision being above the threshold value, that the linked targets are likely to cut into a driving lane of the host vehicle; and controlling, based on determining that the linked targets are likely to cut into the driving lane, the host vehicle to perform an avoidance maneuver.

Determining the possibility of the collision may include: determining, based on the current location of the target vehicle, the current location of the trailer, and the estimated future location of the trailer being outside of the interference zone, that the possibility of the collision is below a threshold value.

Controlling the operation of the host vehicle may include: determining, based on the possibility of the collision being below the threshold value, that the linked targets are unlikely to cut into a driving lane of the host vehicle; and controlling, based on determining that the linked targets are not likely to cut into the driving lane, the host vehicle to maintain a current driving route.

The method may further include: determining, based on a behavior of the target vehicle being same as a behavior of the trailer connected to the target vehicle, that the target vehicle and the trailer are an integrated target; determining whether a current location of the integrated target is within an interference zone located in front of the host vehicle within a threshold distance; determining that a possibility of a collision between the host vehicle and the integrated target is one of: above a threshold value, based on the current location of the integrated target being in the interference zone; or below the threshold value, based on the current location of the integrated target being outside of the interference zone.

The method may further include one of: determining, based on the possibility of the collision between the host vehicle and the integrated target being above the threshold value, that the integrated target is likely to cut into a driving lane of the host vehicle and controlling the host vehicle to perform an avoidance maneuver, or determining, based on the possibility of the collision between the host vehicle and the integrated target being below the threshold value, that the integrated target is unlikely to cut into the driving lane of the host vehicle and controlling the host vehicle to maintain a current driving route.

Comparing the behavior of the target vehicle with the behavior of the trailer may include: comparing heading angles of the target vehicle and the trailer; and comparing absolute speeds of the target vehicle and the trailer.

According to one or more example embodiments of the present disclosure, a vehicle control apparatus of a host vehicle may include: a controller and a speed controller. The controller may be configured to: compare a behavior of a target vehicle with a behavior of a trailer that is connected to the target vehicle; determine, based on the behavior of the target vehicle being different from the behavior of the trailer, that the target vehicle and the trailer as linked targets that affect each other; and determine, based on the linked targets, a possibility of a collision between a host vehicle and the target vehicle to which the trailer is connected; and control, based on the possibility of the collision, an operation of the host vehicle.

The controller may be configured to determine the possibility of the collision by: determining, based on the behavior of the target vehicle, an estimated future location of the trailer; and determining whether at least one of a current location of the target vehicle, a current location of the trailer, or the estimated future location of the trailer is in an interference zone located in front of the host vehicle within a threshold distance.

The controller may be configured to determine the possibility of the collision by: determining, based on at least one of the current location of the target vehicle, the current location of the trailer, or the estimated future location of the trailer being in the interference zone, that the possibility of the collision is above a threshold value.

The controller may be configured to control the operation of the host vehicle by: determining, based on the possibility of the collision being above the threshold value, that the linked targets are likely to cut into a driving lane of the host vehicle; and controlling, based on determining that the linked targets are likely to cut into the driving lane, the host vehicle to perform an avoidance maneuver.

The controller may be configured to determine the possibility of the collision by: determining, based on the current location of the target vehicle, the current location of the trailer, and the estimated future location of the trailer being outside of the interference zone, that the possibility of the collision is below a threshold value.

The controller may be configured to control the operation of the host vehicle by: determining, based on the possibility of the collision being below the threshold value, that the linked targets are unlikely to cut into a driving lane of the host vehicle; and controlling, based on determining that the linked targets are not likely to cut into the driving lane, the host vehicle to maintain a current driving route.

The controller may be further configured to: determine, based on a behavior of the target vehicle being same as a behavior of the trailer connected to the target vehicle, that the target vehicle and the trailer are an integrated target; determine whether a current location of the integrated target is within an interference zone located in front of the host vehicle within a threshold distance; determine that a possibility of a collision between the host vehicle and the integrated target is one of: above a threshold value, based on the current location of the integrated target being in the interference zone; or below the threshold value, based on the current location of the integrated target being outside of the interference zone.

The controller may be further configured to: determine, based on the possibility of the collision between the host vehicle and the integrated target being above the threshold value, that the integrated target is likely to cut into a driving lane of the host vehicle and controlling the host vehicle to perform an avoidance maneuver; and determine, based on the possibility of the collision between the host vehicle and the integrated target being below the threshold value, that the integrated target is unlikely to cut into the driving lane of the host vehicle and controlling the host vehicle to maintain a current driving route.

The controller may be configured to compare the behavior of the target vehicle with the behavior of the trailer by: comparing heading angles of the target vehicle and the trailer; and comparing absolute speeds of the target vehicle and the trailer.

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIG. 1 is a block diagram of a device.

FIG. 2 is a flowchart of a vehicle control method.

FIG. 3 is a diagram illustrating a method of determining whether behaviors of a target vehicle and a trailer are the same.

FIG. 4 is a diagram illustrating a method of applying a method and apparatus for controlling vehicle when it is determined that a current location of a target vehicle is within a control determination region.

FIG. 5A is a diagram illustrating a method of applying a method and apparatus for controlling vehicle when it is determined that a future location of a trailer is within a control determination region.

FIG. 5B is a diagram illustrating a method of applying a method and apparatus for controlling vehicle when it is determined that a future location of a trailer is within a control determination region.

FIG. 6A is a diagram illustrating a method of applying a method and apparatus for controlling vehicle when it is determined that none of a current location of a target vehicle, a current location of a trailer, and a future location of the trailer is within a control determination region.

FIG. 6B is a diagram illustrating a method of applying a method and apparatus for controlling vehicle when it is determined that none of a current location of a target vehicle, a current location of a trailer, and a future location of the trailer is within a control determination region.

FIG. 7 is a block diagram schematically illustrating an example computing device that can be used to implement the method or device.

### DETAILED DESCRIPTION

Hereinafter, one or more example embodiments of the present disclosure will be described in detail with reference to the accompanying drawings. In the following description, like reference numerals preferably designate like elements, although the elements are shown in different drawings. Further, in the following description of the example embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Effective collision avoidance may require accurate prediction of a possibility of a collision.

In at least some implementations of collision prevention system, even in the case of a target vehicle to which a trailer connected, i) the target vehicle and the trailer may be collectively considered as a single entity or ii) the target vehicle and the trailer may be considered as two independent entities, without determining whether the behaviors of the target vehicle and the trailer are the same.

In the case i), although there is a need to consider the target vehicle and the trailer as separate entities because the behaviors of the target vehicle and the trailer are different, the target vehicle and the trailer may each be treated as one entity as in the case in which the behaviors are the same. Therefore, it may not be possible to accurately predict a possibility of a collision between the target vehicle to which the trailer is connected and a subject vehicle.

In the case of ii), although the behavior of the target vehicle affects the behavior of the trailer so it is necessary to consider the behavior of the target vehicle in predicting a future location of the trailer, the target vehicle and the trailer may be considered as two independent entities that do not affect each other and the future location of the trailer may be predicted. In other words, when predicting the future location of the trailer, the behavior of the target vehicle may not have been considered. Therefore, with these implementations of collision prevention system, it might be difficult to accurately predict the future location of the trailer and a possibility of a collision between the target vehicle to which the trailer is connected and the subject vehicle.

Inaccurate prediction of a possibility of a collision may lead to erroneous control of the subject vehicle, making it difficult to ensure the safety of the subject vehicle. In relation to a target vehicle to which a trailer is connected, there is a need for technology for a method and apparatus for accurately predicting a possibility of a collision with a subject vehicle even when the behaviors of the target vehicle and the trailer are different.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., comparing behaviors of a target vehicle and a trailer) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., comparing behaviors of a target vehicle and a trailer) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., comparing behaviors of a target vehicle and a trailer) described herein.

Minimum risk maneuver (MRM) operation(s) may also be controlled, for example, based on one or more features (e.g., comparing behaviors of a target vehicle and a trailer) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., comparing behaviors of a target vehicle and a trailer) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., comparing behaviors of a target vehicle and a trailer) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

The following detailed description, together with the accompanying drawings, is intended to describe one or more example embodiments of the present disclosure, and is not intended to represent the only embodiments in which the present disclosure may be practiced.

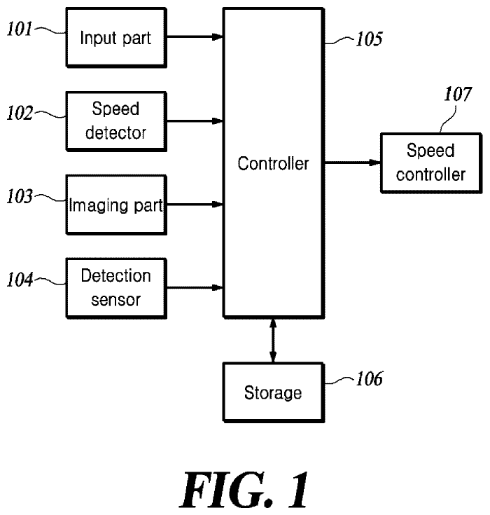

FIG. 1 is a block diagram of an apparatus. The block diagram of the apparatus includes some of all of an input part 101, a speed detector 102, an imaging part 103, a detection sensor 104, a controller 105, a storage 106, and a speed controller 107. Not all blocks shown in FIG. 1 are essential components, and some blocks included in the block diagram of the apparatus may be added, changed, or deleted. Meanwhile, the components shown in FIG. 1 represent functionally distinct elements, and at least one component may be implemented in an integrated form in an actual physical environment.

The input part 101 may be implemented using a physical button, a knob, a touch pad, a touch screen, a stick-type operating device, or a trackball. A driver may control various operations of a vehicle by operating the input part 101.

The speed detector 102 may detect an absolute speed of the subject vehicle under the control of the controller 105. The speed detector 102 may detect a driving speed of the subject vehicle using the absolute speed at which the wheels of the subject vehicle rotate.

The imaging part 103 may recognize the type of an object near the subject vehicle by imaging the object and determining a shape of the imaged object using an image recognition technique, etc., and transfer the recognized information to the controller 105. There is no limit to the location at which the imaging part 103 is installed, and the imaging part 103 may be installed anywhere at which image information may be obtained by imaging the inside or outside of the subject vehicle. The imaging part 103 may include at least one camera and may include a 3D spatial recognition sensor, a radar sensor, or an ultrasonic sensor to obtain more accurate images.

The detection sensor 104 may detect an object approaching from the front, side, or rear of the subject vehicle and acquire location information and absolute speed information of the object. The detection sensor 104 may acquire coordinate information that changes in real time as the object moves.

The controller 105 may perform electronic or mechanical control on each component related to the operation of the subject vehicle. At least one controller 105 may be provided inside the subject vehicle. When the detection sensor 104 detects a target vehicle approaching the subject vehicle, the controller 105 determines whether a trailer is connected to the target vehicle. If it is determined that a trailer is connected, the controller 105 determines the type of target vehicle and trailer. The controller 105 determines the type based on whether behaviors of the target vehicle and the trailer are the same. If it is determined that the behaviors of the target vehicle and the trailer are not the same, the controller 105 determines the type of the target vehicle and the trailer as linked targets. Based on the determined type, the controller 105 determines a possibility of a collision. A possibility of a collision includes both a possibility of a collision between the target vehicle and the subject vehicle and a possibility of a collision between the trailer and the subject vehicle. In this disclosure, it is expressed as a possibility of a collision between the target vehicle to which the trailer is connected and the subject vehicle. If it is determined that there is a possibility of a collision, the controller 105 determines that the linked targets cut-in a driving lane of the subject vehicle and controls the subject vehicle to perform avoidance control. If it is determined that there is no possibility of a collision, the controller 105 determines that the linked targets do not cut-in the driving lane of the vehicle and maintains an existing driving method. Driving method includes a speed and direction of the vehicle.

The storage 106 may store various data related to control of the subject vehicle. Specifically, information regarding a driving speed, a driving distance, and driving time of the subject vehicle may be stored. The storage 106 may store location information and absolute speed information of an object recognized by the imaging part 103 or the detection sensor 104, may store coordinate information that changes in real time of the object on the move, and may store information on a relative distance and relative absolute speed between the subject vehicle and the object. The storage 106 may store data related to formulas and control algorithms for controlling the subject vehicle. The controller 105 may transmit control signals (warning signals, braking instructions, etc.) that control the subject vehicle according to the formulas and control algorithms. This storage 106 may be implemented as at least one of non-volatile memory devices, such as cache, read only memory (ROM), programmable ROM (PROM), erasable programmable ROM (EPROM), electrically erasable programmable ROM (EEPROM), and flash memory, volatile memory devices, such as random access memory (RAM), or storage mediums, such as a hard disk drive (HDD) or CD-ROM, but is not limited thereto.

The speed controller 107 may control the speed of the subject vehicle. The speed controller 107 may include an accelerator driver (not shown) and a brake driver (not shown). The controller 105 may determine whether there is a possibility of a collision between the target vehicle to which the trailer is connected and the subject vehicle based on whether a current location of the target vehicle, a current location of the trailer, and a future location of the trailer are within a control determination region. If there is a possibility of a collision, the controller 105 may transmit a signal for controlling a driving speed of the subject vehicle to the speed controller 107.

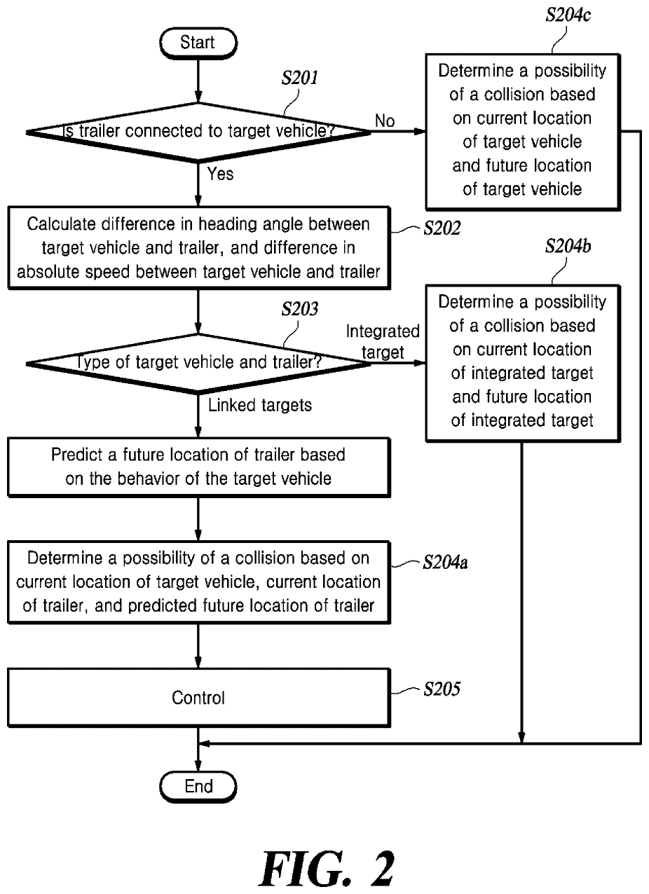

FIG. 2 is a flowchart of a vehicle control method. The controller 105 controls the subject vehicle.

The controller 105 determines whether a trailer is connected to the target vehicle based on the information collected by the imaging part 103 (S201).

If it is determined that a trailer is not connected to the target vehicle, the controller 105 determines a possibility of a collision between the target vehicle and the subject vehicle (S204c).

In this case, the controller 105 determines a possibility of a collision based on the current location of the target vehicle and the future location of the target vehicle. The controller 105 determines that there is a possibility of a collision if either the current location of the target vehicle or the future location of the target vehicle is within the control determination region. If neither the current location of the target vehicle nor the future location of the target vehicle is within the control determination region, the controller 105 determines that there is no possibility of a collision.

The control determination region (also referred to as an interference zone) is a virtual region set. Generally, the control determination region is a certain region in front of the subject vehicle within a threshold distance. If the current location of the target vehicle, the current location of the trailer, or the future location of the trailer is within the control determination region, the controller 105 determines that the target vehicle cuts in the front of the subject vehicle and there is a possibility of a collision (e.g., the possibility of a collision is above a threshold value) between the target vehicle and the subject vehicle or between the trailer and the subject vehicle. In other words, it becomes the standards for determining whether there is a possibility of a collision or not.

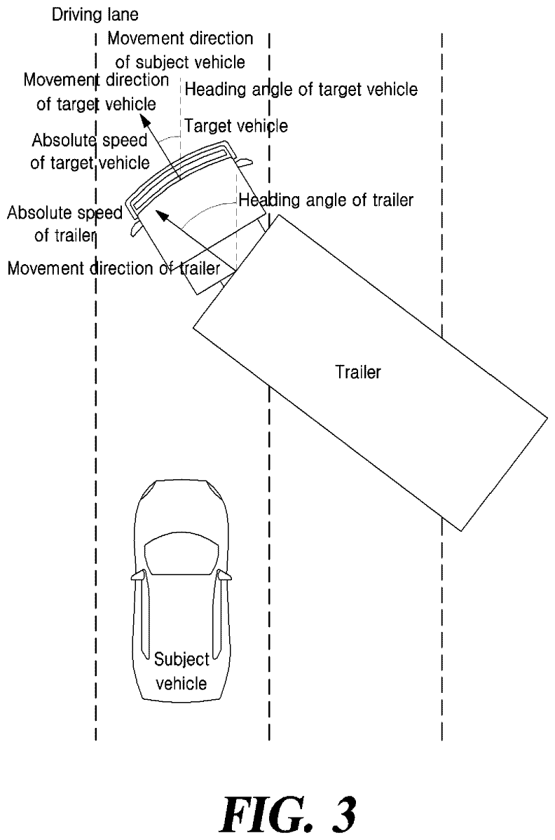

When it is determined that a trailer is connected to the target vehicle, the controller 105 determines whether behaviors of the target vehicle and the trailer are the same. Whether the behaviors are the same may be determined by calculating a difference in heading angle between the target vehicle and the trailer and a difference in absolute speed between the target vehicle and the trailer (S202). The behaviors refer to a movement and a behavior pattern of the target vehicle and the trailer. The behaviors may include changes in how the vehicle drives, changes in absolute speed, and changes in direction. A method of determining whether the behaviors of the target vehicle and the trailer are the same by calculating the difference in heading angle between the target vehicle and the trailer and the difference in absolute speed between the target vehicle and the trailer is described with reference to FIG. 3.

If it is determined that the behaviors of the target vehicle and the trailer are the same, the controller 105 determines the type of the target vehicle and the trailer as an integrated target (S203). The controller 105 considers the target vehicle and the trailer as a single independent entity. Since the behavior of the target vehicle matches that of the trailer, the target vehicle and the trailer may be considered as a single entity.

If it is determined that the behaviors of the target vehicle and the trailer are not the same, the controller 105 determines the type of the target vehicle and the trailer as linked targets (S203). This means that the controller 105 considers the target vehicle and the trailer as two entities that are dependent on each other. Since the two entities are mutually dependent, the behavior of the target vehicle affects the behavior of the trailer, and the behavior of the trailer also affects the behavior of the target vehicle. In general, the behavior of the target vehicle affects the behavior of the trailer, but the behavior of the trailer does not affect the behavior of the target vehicle. This is because the target vehicle has a motor that generates power, while the trailer moves depending on the power of the target vehicle.

Based on the determined type, the controller 105 determines a possibility of a collision between the target vehicle to which the trailer is connected and the subject vehicle.

In the case of the integrated target, the target vehicle and the trailer are considered as one entity, and thus, the controller 105 determines a possibility of a collision between the integrated target and the subject vehicle (S204b). In this case, the controller 105 determines a possibility of a collision based on a current location of the integrated target and a future location of the integrated target. If either a current location of the integrated target or a future location of the integrated target is within the control determination region, the controller 105 determines that there is a possibility of a collision. If neither the current location of the integrated target nor the future location of the integrated target is within the control determination region, the controller 105 determines that there is no possibility of a collision.

In the case of linked targets, the controller 105 predicts a future location of the trailer based on the behavior of the target vehicle. Since the trailer is connected to the target vehicle and follows the path of the target vehicle, the future behavior of the trailer may be predicted based on the current behavior of the target vehicle. The future location of the trailer may be predicted based on the current location of the target vehicle.

The controller 105 determines a possibility of a collision between the linked targets and the subject vehicle (S204a). This means that a possibility of a collision between the target vehicle and the subject vehicle and a possibility of a collision between the trailer and the subject vehicle are all taken into consideration. In this case, the controller 105 determines a possibility of a collision based on the current location of the target vehicle, the current location of the trailer, and the predicted future location of the trailer. The controller 105 determines that there is a possibility of a collision if at least any of the current location of the target vehicle, the current location of the trailer, or the future location of the trailer is within the control determination region. If none of the current location of the target vehicle, the current location of the trailer, and the future location of the trailer is within the control determination region, the controller 105 determines that there is no possibility of a collision.

Based on the determined collision possibility, the controller 105 performs control on the subject vehicle (S205).

If it is determined that there is a possibility of a collision, the controller 105 controls the subject vehicle to perform avoidance control (also referred to as an avoidance maneuver) to prevent a collision. Avoidance control includes control to adjust the driving speed of the subject vehicle, control to change the driving direction of the subject vehicle, etc.

If it is determined that there is no possibility of a collision, the controller 105 allows the vehicle to maintain the existing driving method (e.g., maintain a current driving route). Maintaining the driving method refers to maintaining the driving speed and the driving direction.

FIG. 3 is a diagram illustrating a method of determining whether behaviors of a target vehicle and a trailer are the same. In this disclosure, a difference θ_{Δ} in heading angle between the target vehicle and the trailer and a difference v_{Δ} in absolute speed between the target vehicle and the trailer are calculated to determine whether the behaviors of the target vehicle and the trailer are the same. This is merely a specific example to aid understanding and is not intended to limit the scope of the present disclosure.

The difference θ_{Δ} in heading angle between the target vehicle and the trailer is calculated by i) obtaining each of the heading angle θ_{target} vehicle of the target vehicle and the heading angle θₜᵣₐᵢₗₑᵣ of the trailer, ii) subtracting the heading angle of the trailer from the heading angle of the target vehicle, and iii) taking an absolute value. Equation 1 is an equation of calculating the difference in heading angle between the target vehicle and the trailer.

Regarding i), an imaginary line indicating a movement direction of the vehicle is drawn. Generally, the movement direction of the subject vehicle is the same as the direction of a driving lane. An imaginary line representing the movement direction of the target vehicle and an imaginary line representing the movement direction of the trailer are drawn. An angle formed between the imaginary line representing the movement direction of the target vehicle and the imaginary line representing the movement direction of the vehicle is the heading angle θ_{target vehicle} of the target vehicle. The angle formed between the imaginary line representing the movement direction of the trailer and the imaginary line representing the movement direction of the subject vehicle is the heading angle θₜᵣₐᵢₗₑᵣ of the trailer.

The difference v_{Δ} in absolute speed between the target vehicle and the trailer calculated by i) obtaining each of the absolute speed v_{target vehicle} of the target vehicle and the absolute speed vₜᵣₐᵢₗₑᵣ of the trailer, ii) subtracting the absolute speed of the trailer from the absolute speed of the target vehicle, and iii) taking an absolute value. Equation 2 is an equation of calculating the difference in absolute speed between the target vehicle and the trailer.

Regarding i), the absolute speed of the target vehicle and the absolute speed of the trailer refer to vector values. Regarding ii), subtracting the absolute speed of the trailer from the absolute speed of the target vehicle refers to obtaining a vector difference. Regarding iii), taking an absolute value refers to changing it to a scalar value. It should be noted that the difference in absolute speed between the target vehicle and the trailer is a scalar value.

a) When the difference v_{Δ} in absolute speed between the target vehicle and the trailer is equal to or less than a threshold and the difference θ_{Δ} in heading angle between the target vehicle and the trailer is greater than a threshold, the controller 105 determines that the behaviors of the target vehicle and the trailer are not the same.

b) If the difference v_{Δ} in absolute speed between the target vehicle and the trailer is equal to or less than the threshold and the difference θ_{Δ} in heading angle between the target vehicle and the trailer is equal to or less than the threshold, the controller 105 determines that the behaviors of the target vehicle and the trailer are the same.

c) If the difference v_{Δ} in absolute speed between the target vehicle and the trailer is greater than the threshold, the difference θ_{Δ} in heading angle between the target vehicle and the trailer is not discussed in the present disclosure, regardless of whether the difference θΔ in heading angle between the target vehicle and the trailer is greater than, equal to, or less than the threshold.

$${θ}_{Δ =} \vert {θ}_{target vehicle} - {θ}_{trailer} \vert \qquad [ Equation 1 ]$$

$${v}_{Δ =} \vert {v}_{target vehicle} - {v}_{trailer} \vert \qquad [ Equation 2 ]$$

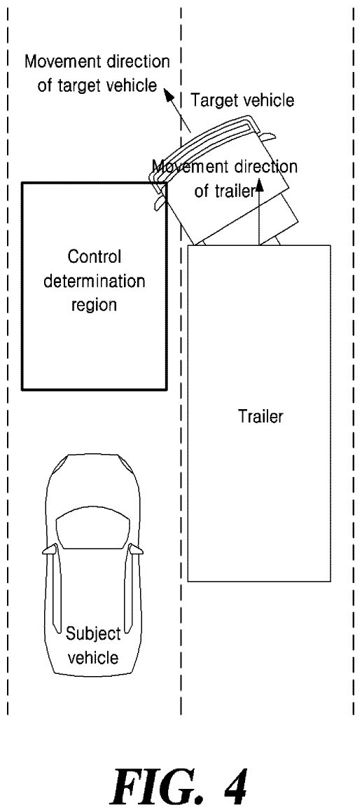

FIG. 4 is a diagram illustrating a method of applying a method and apparatus for controlling vehicle when it is determined that a current location of a target vehicle is within a control determination region.

The controller 105 determines whether the trailer is connected to the target vehicle based on information collected by the imaging part 103. In the case of FIG. 4, the controller 105 determines that the trailer is connected to the target vehicle.

The controller 105 determines whether the behaviors of the target vehicle and the trailer are the same. In the case of FIG. 4, i) the difference v_{Δ} in absolute speed between the target vehicle and the trailer is less than the threshold, and ii) the difference θ_{Δ} in heading angle between the target vehicle and the trailer is greater than the threshold. The controller 105 determines that the behaviors of the target vehicle and the trailer are not the same. The controller 105 determines the type of target vehicle and trailer as linked targets.

The controller 105 predicts a future location of the trailer based on the behavior of the target vehicle and determines a possibility of a collision between the linked targets and the subject vehicle. The controller 105 determines whether at least any of the current location of the target vehicle, the current location of the trailer, or the future location of the trailer is within the control determination region. In the case of FIG. 4, the controller 105 determines that the current location of the target vehicle is within the control determination region. The controller 105 determines that there is a possibility of a collision between the linked targets and the subject vehicle.

The controller 105 controls the subject vehicle to perform avoidance control to prevent a collision between the subject vehicle and the linked targets. Avoidance control may be performed by adjusting the driving speed of the subject vehicle or changing the driving direction of the subject vehicle.

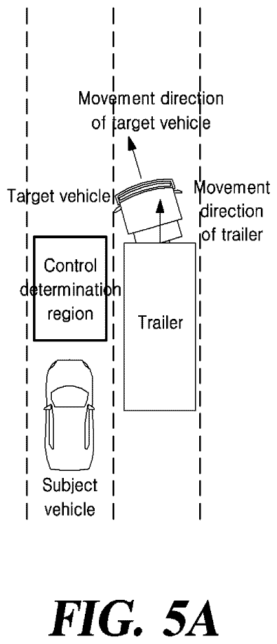

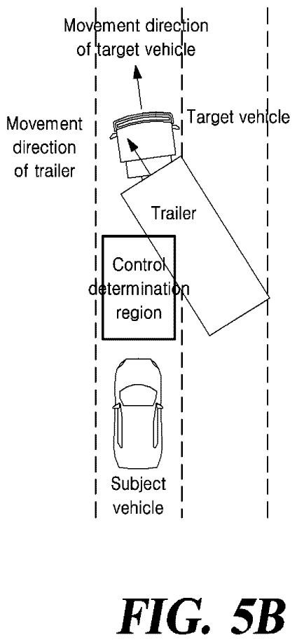

FIG. 5A is a diagram illustrating a method of applying a method and apparatus for controlling vehicle when it is determined that a future location of a trailer is within a control determination region. FIG. 5B is a diagram illustrating a method of applying a method and apparatus for controlling vehicle when it is determined that a future location of a trailer is within a control determination region.

FIG. 5A illustrates the current location of the target vehicle and the current location of the trailer. FIG. 5B illustrates the future location of the target vehicle and the future location of the trailer.

The controller 105 determines whether a trailer is connected to the target vehicle based on the information collected by the imaging part 103. In the case of FIG. 5A and FIG. 5B, the controller 105 determines that a trailer is connected to the target vehicle.

The controller 105 determines whether the behaviors of the target vehicle and the trailer are the same. In the case of FIG. 5A and FIG. 5B, i) the difference v_{Δ} in absolute speed between the target vehicle and the trailer is less than the threshold, and ii) the difference θ_{Δ} in heading angle between the target vehicle and the trailer is greater than the threshold. The controller 105 determines that the behaviors of the target vehicle and the trailer are not the same. The controller 105 determines the type of target vehicle and trailer as linked targets.

The controller 105 predicts the future location of the trailer based on the behavior of the target vehicle and determines a possibility of a collision between the linked targets and the subject vehicle. The controller 105 determines whether at least any of the current location of the target vehicle, the current location of the trailer, or the future location of the trailer is within the control determination region. In the case of FIG. 5A and FIG. 5B, the controller 105 determines that the current location of the target vehicle and the current location of the trailer is not within the control determination region. The controller 105 determines that the future location of the trailer is within the control determination region. The controller 105 determines that there is a possibility of a collision between linked targets and the subject vehicle.

The controller 105 controls the subject vehicle to perform avoidance control to prevent a collision between the subject vehicle and the linked targets. Avoidance control may be performed by adjusting the driving speed of the subject vehicle or changing the driving direction of the subject vehicle.

Meanwhile, at least some implementations are unable to accurately predict a possibility of a collision between the target vehicle to which the trailer is connected and the subject vehicle in the situation shown in FIG. 5A and FIG. 5B. These implementations may predict the future location of an entity based on an average behavior of one entity including the target vehicle and the trailer. Therefore, it may be determined that neither the current location nor the future location of one entity, including the target vehicle and the trailer, is within the control determination region. In other words, it may be determined that there is no possibility of a collision between the target vehicle to which the trailer is connected and the subject vehicle, which may lead to erroneous control.

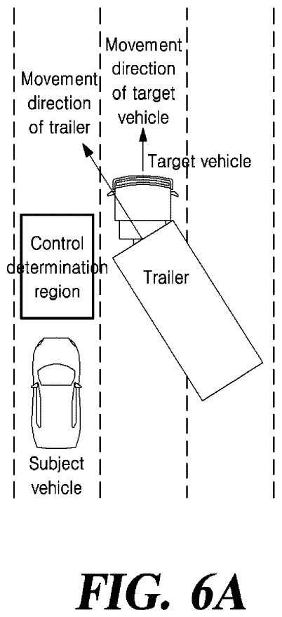

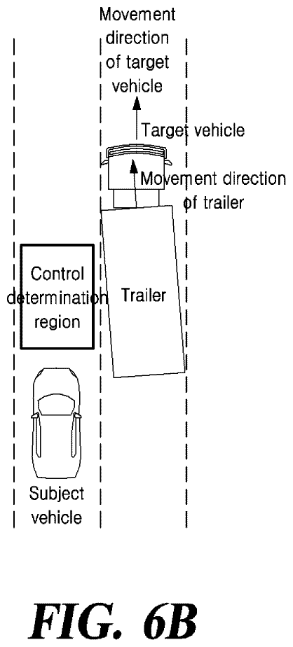

FIG. 6A is a diagram illustrating a method of applying a method and apparatus for controlling vehicle when it is determined that none of a current location of a target vehicle, a current location of a trailer, and a future location of the trailer is within a control determination region. FIG. 6B is a diagram illustrating a method of applying a method and apparatus for controlling vehicle when it is determined that none of a current location of a target vehicle, a current location of a trailer, and a future location of the trailer is within a control determination region.

FIG. 6A illustrates the current location of the target vehicle and the current location of the trailer. FIG. 6B illustrates the future location of the target vehicle and the future location of the trailer.

The controller 105 determines whether a trailer is connected to the target vehicle based on information collected by the imaging part 103. In the case of FIG. 6A and FIG. 6B, the controller 105 determines that a trailer is connected to the target vehicle.

The controller 105 determines whether the behaviors of the target vehicle and the trailer are the same. In the case of FIG. 6A and FIG. 6B, i) the difference v_{Δ} in absolute speed between the target vehicle and the trailer is less than the threshold, and ii) the difference θ_{Δ} in heading angle between the target vehicle and the trailer is greater than the threshold. The controller 105 determines that the behaviors of the target vehicle and the trailer are not the same. The controller 105 determines the type of target vehicle and trailer as linked targets.

The controller 105 predicts a future location of the trailer based on the behavior of the target vehicle and determines a possibility of a collision between the linked targets and the subject vehicle. The controller 105 determines whether at least any of the current location of the target vehicle, the current location of the trailer, or the future location of the trailer is within the control determination region. In the case of FIG. 6A and FIG. 6B, the controller 105 determines that none of the current location of the target vehicle, the current location of the trailer, and the future location of the trailer is within the control determination region. The controller 105 determines that there is no possibility of a collision between the linked targets and the subject vehicle.

The controller 105 allows the subject vehicle to maintain the existing driving method. Maintaining the driving method refers to maintaining the driving speed and driving direction.

Meanwhile, at least some implementations are unable to accurately predict a possibility of a collision between the target vehicle to which the trailer is connected and the subject vehicle in the situation shown in FIG. 6A and FIG. 6B. The prior art may predict the future location of the trailer, without considering the behavior of the target vehicle. Therefore, it may be determined that the future location of the trailer is within the control determination region. In other words, it may be determined that there is a possibility of a collision between the target vehicle to which the trailer is connected and the subject vehicle, which may lead to erroneous control.

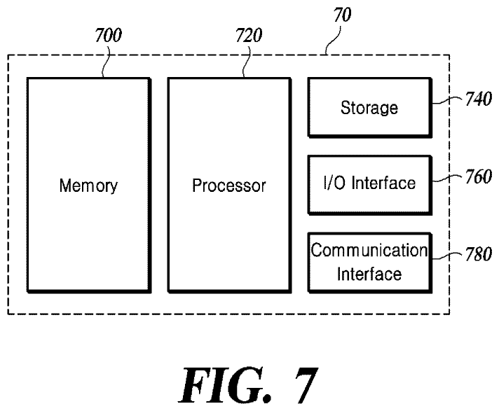

FIG. 7 is a block diagram schematically illustrating an example computing device that can be used to implement the methods or devices.

A computing device 70 may include some or all of a memory 700, a processor 720, a storage 740, an input and output (I/O) interface 760, and a communication interface 780. The computing device 70 may be a stationary computing device such as a desktop computer, a server, or an AI accelerator, or a mobile computing device such as a laptop computer or a smart phone.

The memory 700 may store a program that allows the processor 720 to perform methods or operations. For example, the program may include a plurality of instructions that are executable by the processor 720. The method illustrated in FIG. 2 may thus be performed by the plurality of instructions being executed by the processor 720.

The memory 700 may be a single memory or a plurality of memories. In this case, information required to perform methods or operations may be stored in the single memory or divided and stored in the plurality of memories. When the memory 700 is configured of the plurality of memories, the plurality of memories may be physically separated.

The memory 700 may include at least one of a volatile memory and a non-volatile memory. The volatile memory includes a static random access memory (SRAM), a dynamic random access memory (DRAM), or the like, and the non-volatile memory includes a flash memory.

The processor 720 may include at least one core capable of executing at least one instruction. The processor 720 may execute instructions stored in the memory 700. The processor 720 may be a single processor or a plurality of processors.

The storage 740 maintains stored data even when power supplied to the computing device 70 is cut off. For example, the storage 740 may include a non-volatile memory or may include a storage medium such as a magnetic tape, optical disc, or magnetic disk.

A program stored in the storage 740 may be loaded into the memory 700 before being executed by the processor 720. The storage 740 may store files created in a program language, and a program created from a file by a compiler or the like may be loaded into the memory 700. The storage 740 may store data to be processed by the processor 720 and/or data processed by the processor 720.

The I/O interface 760 may provide an interface with an input device such as a keyboard or mouse, and/or an output device such as a display device or printer. A user can trigger execution of a program in the processor 720 through the input device and/or check a processing result of the processor 720 through the output device.

The communication interface 780 may provide access to an external network. For example, the computing device 70 may communicate with another device via the communication interface 780.

At least some of the components described herein may be implemented as hardware elements, including at least one or a combination of digital signal processor (DSP), processors, controllers, application-specific IC (ASIC), programmable logic device (e.g., FPGA), and other electronic devices. In addition, at least some of the functions or processes described herein may be implemented as software, and the software may be stored on a recording medium. At least some of the components, functions, and processes described in this disclosure may be implemented as a combination of hardware and software.

Methods according to the present disclosure may be written as programs executable on a computer and may also be implemented on various recording mediums, such as magnetic storage medium, optical readout medium, digital storage medium.

Implementations of the various techniques described herein may be implemented as digital electronic circuitry, or as computer hardware, firmware, software, or combinations thereof. Implementations may be implemented as computer program products, i.e., computer programs tangibly embodied in an information carrier, e.g., a machine-readable storage device (computer-readable medium) or a radio signal, for processing by a data processing device, e.g., a programmable processor, a computer, or the operation of a plurality of computers, or for controlling the operation of a plurality of computers.

The present disclosure provides a vehicle control method performed in a system mounted on a subject vehicle to prevent a collision with a target vehicle to which a trailer is connected, the vehicle control method comprising: determining whether behaviors of the target vehicle and the trailer are the same; determining a type of the target vehicle and the trailer as linked targets that affect each other, when the behaviors of the target vehicle and the trailer are not the same; and determining a possibility of a collision between the target vehicle to which the trailer is connected and the subject vehicle, based on a determined type.

The present disclosure provides a vehicle control apparatus comprising: a detection sensor; a controller; and a speed controller, wherein the controller is to: determine whether behaviors of a target vehicle and a trailer are the same; determine a type of the target vehicle and the trailer as linked targets that affect each other, when the behaviors of the target vehicle and the trailer are not the same; and determine a possibility of a collision between the target vehicle to which the trailer is connected and a subject vehicle, based on a determined type.

In the case of a target vehicle to which a trailer is connected, the type is determined based on whether the behaviors of the target vehicle and the trailer are the same. In the case of a connected target, the target vehicle and the trailer are considered as two entities, thereby improving the accuracy of collision avoidance compared to at least some implementations in which the target vehicle and the trailer are considered as one entity.

In a case in which a trailer is connected to a target vehicle and behaviors of the target vehicle and the trailer are not the same, a future location of the trailer is predicted based on the behavior of the target vehicle. Thus, the accuracy of collision prevention may be improved, compared to at least some implementations in which the behavior of the target vehicle is not considered in the prediction of a future location of the trailer.

Although this specification includes details of a number of specific implementations, they should not be understood as limiting the present disclosure or the scope of what may be claimed, but rather as a description of features that may be peculiar to one or more particular embodiments. Certain features described herein in the context of one or more example embodiments may be implemented in combination in a single embodiment. Conversely, various features described in the context of a single embodiment may also be implemented individually or in any suitable sub-combination in a plurality of embodiments. Further, while features may operate in a particular combination and may be initially described as claimed as such, one or more features of a claimed combination may be excluded from that combination in some instances, and the claimed combination may be changed to a sub-combination or variation of a sub-combination.

The one or more example embodiments of the present disclosure and the drawings are shown by way of illustration only and are not intended to limit the scope of the present disclosure. That other modifications based on the technical ideas may be practiced in addition to the example embodiments disclosed herein will be apparent to one of ordinary skill in the art to which the present disclosure belongs.

The scope of protection of the present disclosure herein shall be construed in accordance with the claims below, and all technical ideas within the scope thereof shall be construed to be included within the scope of the claims herein.

What is claimed is:

1. A method performed by an apparatus of a host vehicle, the method comprising:
comparing a behavior of a target vehicle with a behavior of a trailer that is connected to the target vehicle;
determining, based on the behavior of the target vehicle being different from the behavior of the trailer, that the target vehicle and the trailer are linked targets that affect each other;
determining, based on the linked targets, a possibility of a collision between the host vehicle and the target vehicle to which the trailer is connected; and
controlling, based on the possibility of the collision, an operation of the host vehicle.

2. The method of claim 1, wherein the determining of the possibility of the collision comprises:
determining, based on the behavior of the target vehicle, an estimated future location of the trailer; and
determining whether at least one of a current location of the target vehicle, a current location of the trailer, or the estimated future location of the trailer is in an interference zone located in front of the host vehicle within a threshold distance.

3. The method of claim 2, wherein the determining of the possibility of the collision comprises:
determining, based on at least one of the current location of the target vehicle, the current location of the trailer, or the estimated future location of the trailer being in the interference zone, that the possibility of the collision is above a threshold value.

4. The method of claim 3, wherein the controlling of the operation of the host vehicle comprises:
determining, based on the possibility of the collision being above the threshold value, that the linked targets are likely to cut into a driving lane of the host vehicle; and
controlling, based on determining that the linked targets are likely to cut into the driving lane, the host vehicle to perform an avoidance maneuver.

5. The method of claim 2, wherein the determining of the possibility of the collision comprises:
determining, based on the current location of the target vehicle, the current location of the trailer, and the estimated future location of the trailer being outside of the interference zone, that the possibility of the collision is below a threshold value.

6. The method of claim 5, wherein the controlling of the operation of the host vehicle comprises:
determining, based on the possibility of the collision being below the threshold value, that the linked targets are unlikely to cut into a driving lane of the host vehicle; and
controlling, based on determining that the linked targets are not likely to cut into the driving lane, the host vehicle to maintain a current driving route.

7. The method of claim 1, further comprising:
determining, based on a behavior of the target vehicle being same as a behavior of the trailer connected to the target vehicle, that the target vehicle and the trailer are an integrated target;
determining whether a current location of the integrated target is within an interference zone located in front of the host vehicle within a threshold distance; and
determining that a possibility of a collision between the host vehicle and the integrated target is one of:
above a threshold value, based on the current location of the integrated target being in the interference zone; or
below the threshold value, based on the current location of the integrated target being outside of the interference zone.

8. The method of claim 7, further comprising one of:
determining, based on the possibility of the collision between the host vehicle and the integrated target being above the threshold value, that the integrated target is likely to cut into a driving lane of the host vehicle and controlling the host vehicle to perform an avoidance maneuver, or
determining, based on the possibility of the collision between the host vehicle and the integrated target being below the threshold value, that the integrated target is unlikely to cut into the driving lane of the host vehicle and controlling the host vehicle to maintain a current driving route.

9. The method of claim 1, wherein the comparing of the behavior of the target vehicle with the behavior of the trailer comprises:
comparing heading angles of the target vehicle and the trailer; and
comparing absolute speeds of the target vehicle and the trailer.

10. A vehicle control apparatus of a host vehicle, the vehicle control apparatus comprising:
a controller; and
a speed controller,
wherein the controller is configured to:
compare a behavior of a target vehicle with a behavior of a trailer that is connected to the target vehicle;
determine, based on the behavior of the target vehicle being different from the behavior of the trailer, that the target vehicle and the trailer as linked targets that affect each other;
determine, based on the linked targets, a possibility of a collision between a host vehicle and the target vehicle to which the trailer is connected; and
control, based on the possibility of the collision, an operation of the host vehicle.

11. The vehicle control apparatus of claim 10, wherein the controller is configured to determine the possibility of the collision by:
determining, based on the behavior of the target vehicle, an estimated future location of the trailer; and
determining whether at least one of a current location of the target vehicle, a current location of the trailer, or the estimated future location of the trailer is in an interference zone located in front of the host vehicle within a threshold distance.

12. The vehicle control apparatus of claim 11, wherein the controller is configured to determine the possibility of the collision by:
determining, based on at least one of the current location of the target vehicle, the current location of the trailer, or the estimated future location of the trailer being in the interference zone, that the possibility of the collision is above a threshold value.

13. The vehicle control apparatus of claim 12, wherein the controller is configured to control the operation of the host vehicle by:
determining, based on the possibility of the collision being above the threshold value, that the linked targets are likely to cut into a driving lane of the host vehicle; and
controlling, based on determining that the linked targets are likely to cut into the driving lane, the host vehicle to perform an avoidance maneuver.

14. The vehicle control apparatus of claim 11, wherein the controller is configured to determine the possibility of the collision by:
determining, based on the current location of the target vehicle, the current location of the trailer, and the estimated future location of the trailer being outside of the interference zone, that the possibility of the collision is below a threshold value.

15. The vehicle control apparatus of claim 14, wherein the controller is configured to control the operation of the host vehicle by:
determining, based on the possibility of the collision being below the threshold value, that the linked targets are unlikely to cut into a driving lane of the host vehicle; and
controlling, based on determining that the linked targets are not likely to cut into the driving lane, the host vehicle to maintain a current driving route.

16. The vehicle control apparatus of claim 10, wherein the controller is further configured to:
determine, based on a behavior of the target vehicle being same as a behavior of the trailer connected to the target vehicle, that the target vehicle and the trailer are an integrated target;
determine whether a current location of the integrated target is within an interference zone located in front of the host vehicle within a threshold distance; and
determine that a possibility of a collision between the host vehicle and the integrated target is one of:
above a threshold value, based on the current location of the integrated target being in the interference zone; or
below the threshold value, based on the current location of the integrated target being outside of the interference zone.

17. The vehicle control apparatus of claim 16, wherein the controller is further configured to:
determine, based on the possibility of the collision between the host vehicle and the integrated target being above the threshold value, that the integrated target is likely to cut into a driving lane of the host vehicle and controlling the host vehicle to perform an avoidance maneuver; and
determine, based on the possibility of the collision between the host vehicle and the integrated target being below the threshold value, that the integrated target is unlikely to cut into the driving lane of the host vehicle and controlling the host vehicle to maintain a current driving route.

18. The vehicle control apparatus of claim 10, wherein the controller is configured to compare the behavior of the target vehicle with the behavior of the trailer by:
comparing heading angles of the target vehicle and the trailer; and
comparing absolute speeds of the target vehicle and the trailer.
